(19) United States
(12) Patent Application Publication
(10) Pub. No.: US 2025/0360628 A1
(43) Pub. Date: Nov. 27, 2025

(54) AUTOMATED WORKPIECE MACHINING BASED ON SENSED FORCES BETWEEN A TOOL AND A SURFACE OF A WORKPIECE

(71) Applicant: Carleton University, Ottawa (CA)

(72) Inventors: Mojtaba Ahmadi, Ottawa (CA); Rishad Irani, Ottawa (CA); Steffan Lloyd, Oslo (NO); Mohammadreza Dehghanitafti, Ottawa (CA); Ryan McKenzie, Ottawa (CA); Wade MacMillan, Ottawa (CA); Grael Miller, Ottawa (CA)

(21) Appl. No.: 18/674,449

(22) Filed: May 24, 2024

(51) Int. Cl. B25J 9/16; B25J 11/00

(52) U.S. Cl. CPC B25J 9/1697; B25J 9/1633; B25J 9/1664; B25J 11/006

(57) ABSTRACT

Systems and methods relating to automated machining. A machining tool is controlled by an industrial robot that guides the tool around the contour of a workpiece. As the tool traverses the estimated contour of the workpiece, the tool machines the surface while a force sensor provides force readings, the force readings being readings of the force exerted by the tool on the surface. The path followed by the tool around the contour of the workpiece is adjusted based on the force readings. The speed at which the tool traverses the workpiece may be modulated and the path may be adjusted based on estimated tool wear.

### TECHNICAL FIELD

The present invention relates to automated machining. More specifically, the present invention relates to systems and methods for automated machining, including deburring, of a workpiece based on force readings of a force exerted by a tool on the surface of the workpiece.

### BACKGROUND

Modern manufacturing requires flexible systems to allow for high customizability and scalability of production. Industrial robots are key to this paradigm, as they are cost-effective, have large operational workspaces, high dexterity, and are easily repurposed or scaled as required. However, current robot usage is limited primarily to simple, non-interactive tasks, and machining operations such as deburring, grinding, milling, or polishing are only implemented on industrial robots in few specific situations and account for only 0.6% of global usage. Often cited reasons for the low adoption in machining operations are poor accuracy, difficulty localizing workpieces within the robot's workspace, and slow cycle times due to high process complexity. Because of these challenges, manual methods are still prevalent in many industries, particularly aerospace and automotive, and represent a large cost. Novel methods of improving robot accuracy and simplifying robotic machining operations are thus highly desirable.

As noted above, deburring is one task in which robots have been used in the past. However, robot use in deburring is still not a preferred route. As is known, deburring is an additional operation required after many metal-forming processes. Punching and shearing produce tear burrs, while nibbling, which involves overlapping die punches, creates sharp scallops that require removal. Nibbling also leaves index tabs—an intentional scallop to hold the workpiece during operations. These imperfections can cut a worker's hand, damage electrical cables, prevent parts from mating properly, cause early corrosion, or allow for crack initiation and lead to early failure. In the aerospace industry, strict tolerances, low production volume, and varied workpiece sizes render current automation systems unsuitable, and manual hand deburring is widely employed instead. Hand deburring is also prevalent in the automotive sector because of high part complexity. Unfortunately, manual deburring is costly and error-prone. It is associated with high worker turnover and respiratory and vibration-induced health risks. Consequently, manual deburring is challenging to scale and is often identified as a bottleneck in industry. Studies have reported that deburring can comprise anywhere from 9% to 35% total manufacturing costs. Thus, it is highly desirable to automate this process and to allow for more flexible and scalable deburring in manufacturing.

There is, therefore, a need for systems and methods that allow for accurate machining of workpieces by industrial robots.

### SUMMARY

The present invention provides systems and methods relating to automated machining. A machining tool is controlled by an industrial robot that guides the tool around the estimated contour of a workpiece. As the tool traverses the contour of the workpiece, the tool machines the surface while a force sensor provides force readings, the force readings being readings of the force exerted by the tool on the surface. The path followed by the tool around the contour of the workpiece is adjusted based on the force readings. The speed at which the tool traverses the workpiece may be modulated and the path may be adjusted based on estimated tool wear.

In a first aspect, the present invention provides a system for automatedly accomplishing machining tasks on a workpiece, the system comprising:
a data processing subsystem for controlling an industrial robot coupled to a machining tool, said data processing subsystem being for controlling said machining tool to follow a contour of said workpiece;
an imaging subsystem for imaging said workpiece, an image of said workpiece being used by said data processing subsystem to determine an initial path for said machining tool to follow around said contour;
a force sensor coupled to a machining tool, said force sensor providing a force reading to said data processing subsystem, said force reading being an amount of force sensed by said force sensor;
wherein
said data processing subsystem adjusts a path for said machining tool based on said force reading;
said machining tool machines said workpiece as said machine tool follows said contour.

In a second aspect, the present invention provides a method for machining a workpiece using an industrial robot, the method comprising:
a) obtaining an image of said workpiece;
b) determining an initial path along a contour of said workpiece, said initial path being based on an estimated location of a surface of said contour of said workpiece, wherein a followed path initially conforms to said initial path, said followed path being a path to be followed by said robot with a machine tool along a contour of said workpiece to thereby machine said workpiece;
c) receiving a force reading from a force sensor coupled to said machine tool, said force reading being an indication of a force exerted by said machine tool on said workpiece as said machine tool follows said surface of said contour of said workpiece;
d) adjusting said followed path for said machine tool based on said force reading;
e) repeating steps c) and d) as said machine tool traverses said contour.

In a further aspect, the method includes adjusting a speed at which the machine tool follows the followed path traverses said contour. The step d) may be executed to maintain a predetermined force reading from the force sensor.

Yet a further aspect provides that the machine tool traverses the contour at a constant speed. However, speed is modulated when the force reading is outside a predetermined force range.

In a further aspect, the force is modeled as a spring and a spring constant is adjusted based on a difference between the initial path and the followed path such that when the difference is within a predetermined range, the followed path is less likely to deviate from said initial path.

Similarly, in another aspect, the method includes adjusting a virtual stiffness parameter based on differences between the followed path and the initial path.

It should be clear that the image may be obtained using any one of: a laser scanner or a camera subsystem. As well, the contour of said workpiece is deburred as the machine tool traverses the contour of the workpiece.

For another aspect of the present invention, the method includes adjusting a speed at which the machine tool follows the followed path based on differences between the followed path and the initial path. The method may also include applying a velocity correction factor to thereby control a rate at which the followed path is adjusted. In addition, the method may include adjusting the followed path based on an estimated or actual rate at which the machining tool wears.

### BRIEF DESCRIPTION OF THE DRAWINGS

The embodiments of the present invention will now be described by reference to the following figures, in which identical reference numerals in different figures indicate identical elements and in which:

FIG. 1 is a diagram illustrating the coordinate systems used by the present invention as well as the various components used in an embodiment of the present invention;

FIG. 2 is a diagram detailing the nomenclature used for workpiece-tool interactions, with uncertain registration and tool size, as explained in accordance with one of the embodiments of the present invention;

FIG. 3 is a diagram also detailing the nomenclature for a setup according to another embodiment of the present invention;

FIGS. 4A-4D are illustrations of architectures of the various embodiments of the present invention;

FIGS. 5A-5B illustrate visualizations of workpiece-tool contact models as used in different embodiments of the present invention;

FIGS. 6A-6C illustrate the various variables and their physical counterparts for contour primitives;

FIG. 7 shows a feedrate/speed modulation curve in accordance with one embodiment of the present invention;

FIG. 8 is an image of an implementation of the present invention showing the various components of one aspect of the present invention; and

FIG. 9 is a flowchart detailing the steps in a method according to another aspect of the present invention.

### DETAILED DESCRIPTION

To better understand the present invention, the reader is directed to the listing of citations at the end of this description. For ease of reference, these citations and references have been referred to by their listing number throughout this document. The contents of the citations in the list at the end of this description are hereby incorporated by reference herein in their entirety.

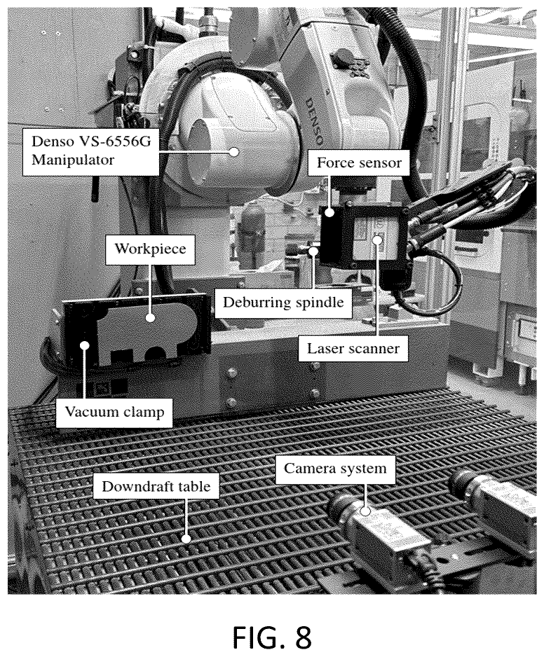

The present invention relates to systems and methods for machining a workpiece. In the detailed discussions below, a planar workpiece is machined to deburr the contour of the workpiece using an industrial robot controlled by a data processing device implementing a method according to one aspect of the present invention. In one implementation of the present invention, illustrated in FIG. 8, the system includes an industrial robot (a Denso VS-6556 manipulator), an imaging subsystem (a laser scanner and a camera system), a machining tool (the deburring tool), and a force sensor coupled to the robot and to the tool. As can be imagined, the operation of the manipulator/robot to machine the workpiece using the tool is controlled by the data processing subsystem. The computer vision subsystem (which may be the laser scanner or the camera subsystem by themselves) initially takes an image of the workpiece and this image is used to determine a path for the tool to follow around the contour of the workpiece. As the tool follows this initial path, the path followed by the tool is dynamically adjusted by the data processing subsystem based on the force sensed by the force sensor. Other machining tools other than a deburring tool may be used.

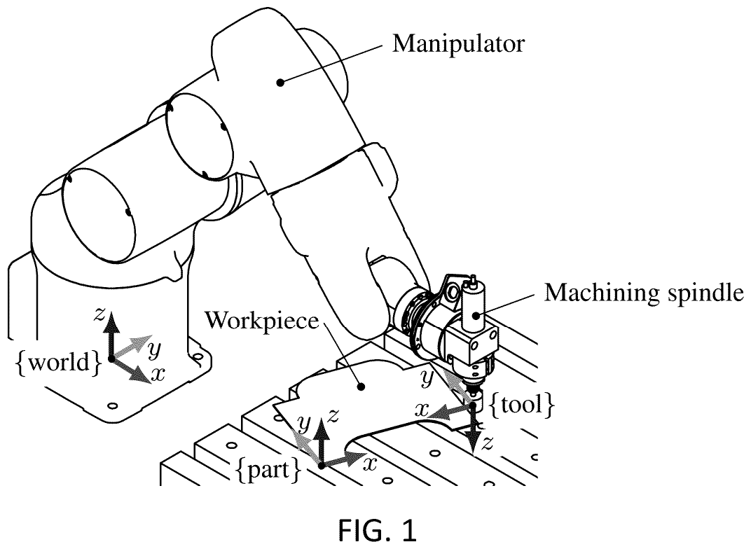

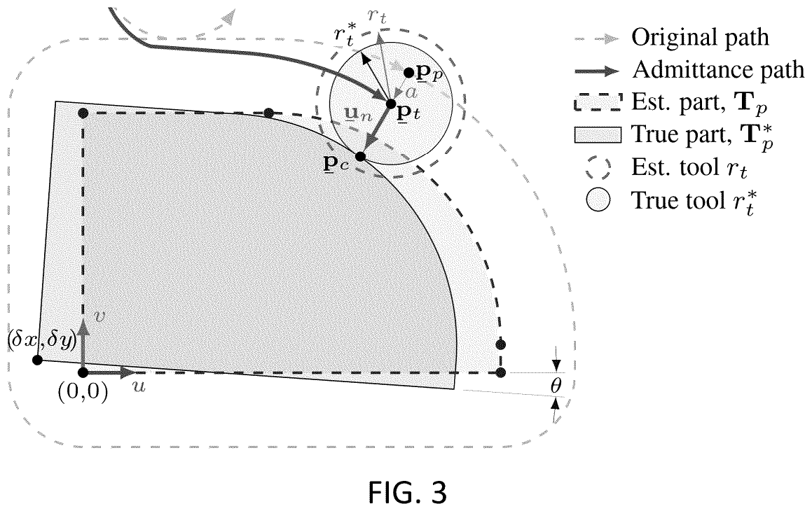

To better understand the explanation of the present invention, the reader is directed to the nomenclature explained below and in reference to FIG. 1 and FIG. 3.

The present invention relates to the robotic machining of the contours of planar parts. Let

$${T}_{p}^{*}$$

denote the homogeneous transformation matrix between different frames, and let Tₚ denote a known estimate of this transformation, obtained a priori via an imaging system, jigging, or similar. The machining tool is modeled as a cylinder of radius

$${r}_{t}^{*} ,$$

and we let rₜ denote an a priori estimate of this quantity. The geometry of the part is assumed to be available in terms of primitives such as lines, arcs, and points, and it is assumed that a contouring path is planned around the part, as shown in FIG. 3, consisting of a time-series of 3D points pₚ, and unit-length normal direction vectors uₙ. Such path planning is known and references [1], [2], [3], and [4] may be consulted for convenience. Similarly, such path planning may be accomplished using various CAD/CAM software packages. An admittance controller is employed to correct for path errors by modifying the tool center along the normal axis uₙ by an admittance correction α to maintain a desired normal force ƒ_{d} from the measured force ƒ, such that

$${p}_{t} = {p}_{p} + a {u}_{n} , \qquad ( 1 )$$

$$\ddot{a} = \frac{1}{{m}_{a}} [ {f}_{d} - f - {b}_{a} \dot{a} - {k}_{a} a ] , a = \int \int \ddot{a} dtdt , \qquad ( 2 )$$

where m_{α}, k_{α}, and b_{α} are virtual mass-spring-damper coefficients used to tune the “virtual suspension” of the controller.

In one non-limiting embodiment, workpieces are assumed planar, and we define the part plane πₚ from the xy plane of Tₚ as

$${Π}_{p} = \{ p ∈ {ℝ}^{3} \vert p = {d}_{p} + u {u}_{x p} + v {u}_{yp} , u , v ∈ ℝ \} , \qquad ( 3 )$$

where uₓₚ and u_{yp} are the unit vectors along the x and y axes of Tₚ, dₚ the translation vector of Tₚ, and u, v are the planar coordinates of the point p—noting that, for this document, the underbar under a variable denotes 2D planar variables from their 3D counterparts. Projection of a point p∈ [symbol] ³ to a point p∈πₚ and back can be accomplished as

$$\underline{p} = {[ \begin{matrix}{u}_{xp} & {u}_{yp}\end{matrix} ]}^{T} ( \underline{p} - {d}_{p} ) , \qquad ( 4 )$$

$$p = [ \begin{matrix}{u}_{xp} & {u}_{yp}\end{matrix} ] + {d}_{p} .$$

Vectors are similarly converted without the shift of origin dₚ.

Within the plane πₚ, the uncertainty of the workpiece and tool can be described using a four-state vector

$$ρ = {[ \begin{matrix}δ x & δ y & θ & δ r\end{matrix} ]}^{T} \qquad ( 5 )$$

where δx, δy, and θ are horizontal, vertical, and rotational workpiece corrections, and &r is a tool radius correction. This state vector defines the corrected part frame \tilde{T}ₚ and tool radius r̅ₜ=rₜ+δr—again noting that in this document, the tilde above a variable denotes the current estimate of a variable, transformed by p, while those without represent the initial estimate.

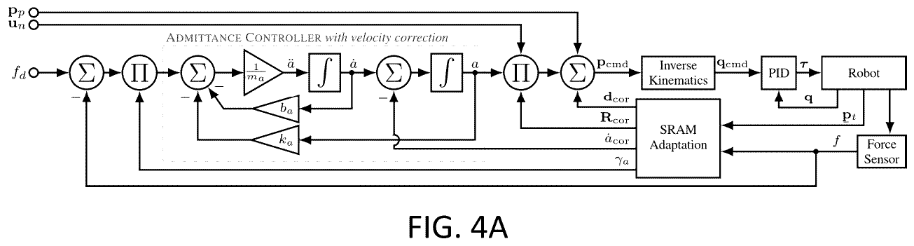

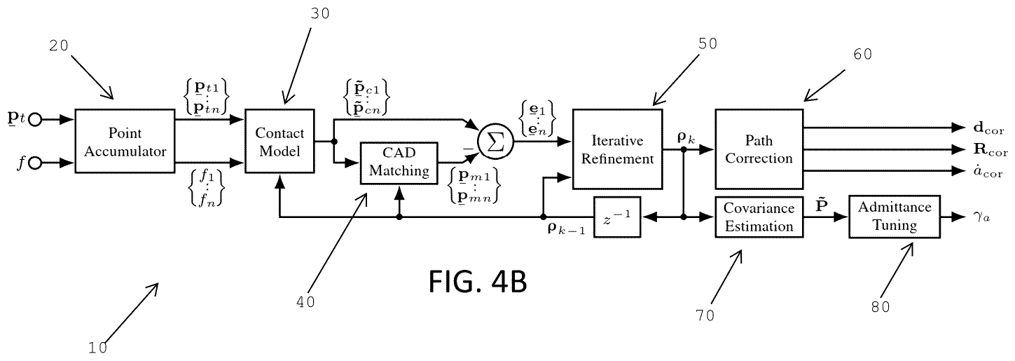

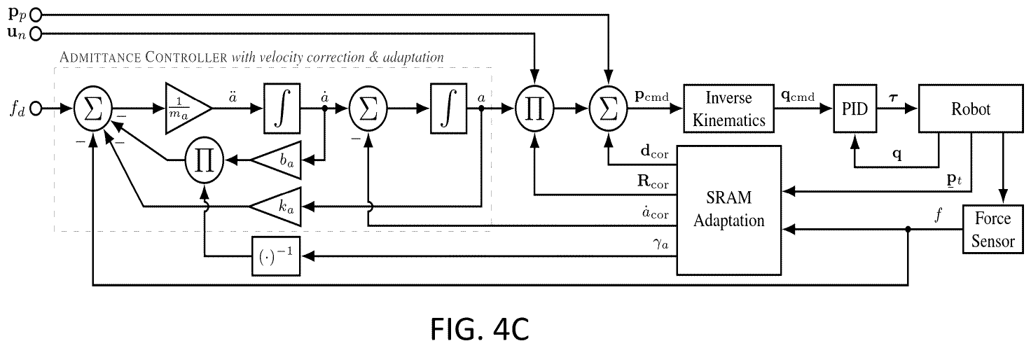

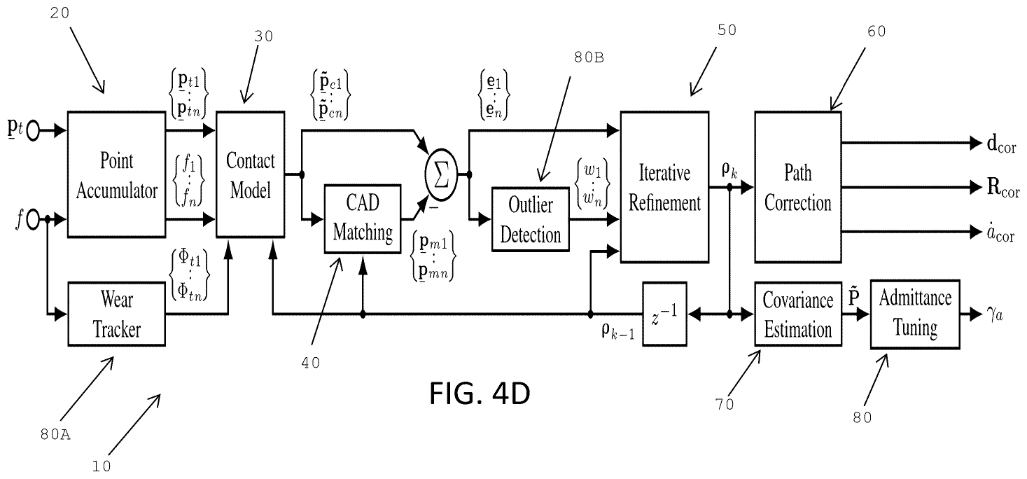

In one aspect, this embodiment of the present invention modifies the admittance relationship in (2) by allowing for real-time adaptation of the workpiece registration and tool radius to minimize the corrections required by the controller. Simultaneously, a live covariance estimate is computed and leveraged to modulate the admittance tuning optimally. FIG. 4A illustrates the overall control architecture used in the present invention. A desired force ƒ_{d}, target pose pₚ, and normal vector uₙ are provided by the path planner. A standard admittance controller modulates the target pose along the normal axis to maintain the target force. An inverse kinematics block converts the target pose to joint angles, which are sent to the joint servos. At the same time, an adaption block records the measured position pₜ and part interaction forces ƒ to update the state estimate and compute a path correction d_{cor}, a rotational correction matrix R_{cor}, and an admittance velocity correction term \dot{a}_{cor}. Finally, an admittance tuning parameter γ_{α} is calculated from an estimate of the state covariance—allowing for the controller to behave rapidly before knowledge of the workpiece location is obtained, then transition naturally to be a stiff controller as the registration improves.

The architecture of the adaptation system 10 according to one aspect of the present invention is shown in FIG. 4B. First, the point accumulator 20 records the incoming planar tool coordinates pₜ and forces ƒ to form a list of all observations in the current run. The contact model system 30 estimates workpiece-tool contact points p_{ci} from each observation. The CAD matching 40 relates the estimated contact points with corresponding points on the CAD model, pₘᵢ. The matched points and contact points are subtracted to form a set of residuals eᵢ and used by the iterative refinement block 50 to compute state updates to p. The path correction system 60 computes d_{cor}, R_{cor}, and \dot{a}_{cor} from the state estimate p. Finally, the covariance estimation system 70 estimates a state covariance matrix \tilde{P}, which is then used by the admittance tuning block 80 to compute an admittance tuning factor γ_{α}.

Referring to the architecture of the aspect of the present invention that is illustrated in FIG. 4B, the architecture includes a point accumulator block. The point accumulator block's purpose is to build up a list of relevant observations, pₜᵢ and ƒᵢ, of workpiece-tool contacts. To avoid this list of observations from becoming overly large, two strategies may be used. First, an observation is only considered relevant (and thus logged) if the tool is in contact with the workpiece—this can be deduced by comparing the measured force ƒᵢ to a set threshold. Second, observations are logged at a lower frequency than the overall controller by downsampling the input, with appropriate anti-alias lowpass filtering, before processing.

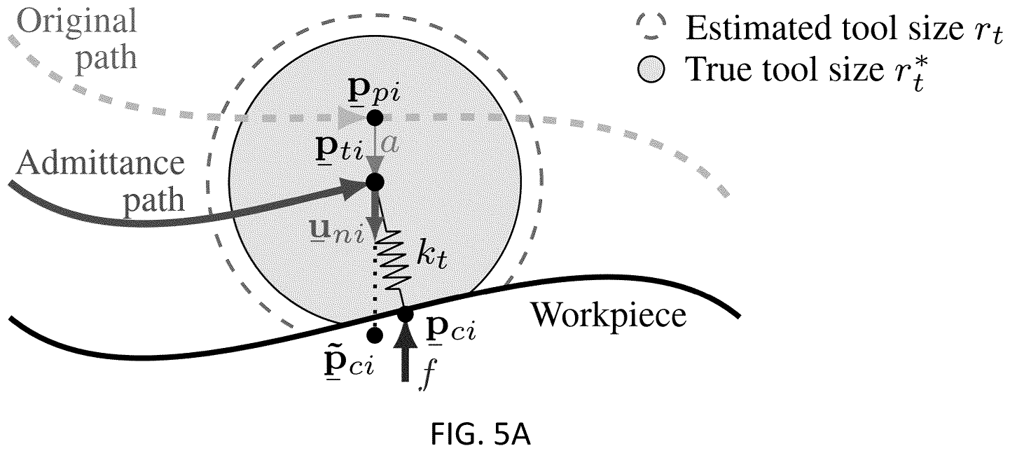

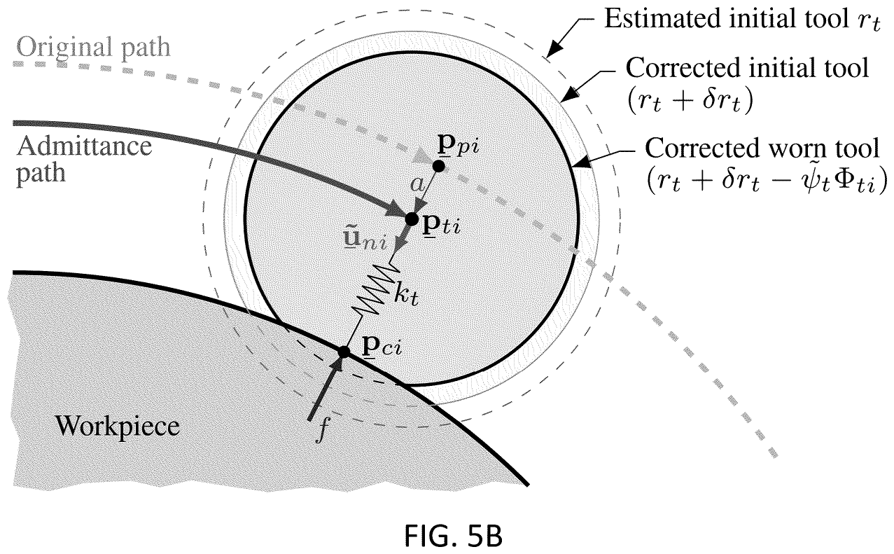

Returning to the architecture in FIG. 4B, the architecture also includes a contact model block. The contact model block converts the set of n observed tool coordinates pₜᵢ and forces ƒᵢ into a set of n workpiece-tool contact points \tilde{p}_{ci}. The estimation models the workpiece-tool contact as a spring of stiffness kₜ, as shown in FIG. 5. While kₜ is shown as the tool stiffness, in reality this stiffness combines the stiffnesses of the tool, the part and the manipulator. Accordingly, the block output \tilde{p}_{ci} is

$${\underline{\tilde{p}}}_{ci} = {\underline{p}}_{ti} + ( {r}_{t} + δ r - {f}_{i} / {k}_{t} ) {\underline{R}}_{θ} {u}_{ni} , \qquad ( 6 )$$

with R_{θ} as the 2D rotation matrix of the angle θ.

After the tool coordinate observations have been converted, the next step is to match each of the estimated workpiece-tool contact points \tilde{p}_{ci} to their correspondences on the CAD model, denoted by pₘᵢ. First, the CAD model must be updated with the most recent state estimate ρₖ. The estimated correspondences can then be computed as the closest point on the CAD model. The CAD model is broken into basic primitives such as lines, arcs, and points, analogous to the DXF format commonly used in industry. For each entity, geometric formulae exist to compute these closest points analytically. For clarity, the methods used in [6] and [7] may be used.

We define the residuals of \tilde{p}ᵢ and pₘᵢ as eᵢ=\tilde{p}_{ci}−pₘᵢ. Iterative refinement is accomplished by minimizing the nonlinear quadratic cost function

$$L ( ρ ) = \frac{1}{2} {ρ}^{T} {P}_{0}^{- 1} ρ + \frac{1}{2} {\sum }_{i = 1}^{n} {\underline{e}}_{i}^{T} {S}_{i}^{- 1} {\underline{e}}_{i} , \qquad ( 7 )$$

where P₀∈ [symbol] ^{4×4} and Sᵢ∈ [symbol] ^{2×2} are positive definite matrices of the initial state covariance and the measurement covariance of the i th sample eᵢ, respectively. The first quadratic term acts as an L₂ regularization term, drawing the solution towards the initial state estimate in the absence of better data, and the second term minimizes the squared norm of the residual vectors. Each term is weighted by its respective reciprocal covariance

$$( {P}_{0}^{- 1} or {S}_{i}^{- 1} ) ,$$

ensuring that the resulting minimum is optimal, in the sense of minimizing the variance across all information sources.

Iterative refinement of L(ρ) can be accomplished using a second-order Newton step update at each controller cycle to reach the stationary optimal point where ∇L(ρ)=0, as

$${ρ}_{k} = {ρ}_{k - 1} - {[ {∇}^{2} L ( ρ ) ]}^{- 1} ∇ L ( ρ ) , \qquad ( 8 )$$

where the associated gradient and Hessian are

$$∇ L ( ρ ) = {P}_{0}^{- 1} ρ + {\sum }_{i = 1}^{n} ∇ {\underline{e}}_{i}^{T} {S}_{i}^{- 1} {\underline{e}}_{i} , \qquad ( 9 )$$

$${∇}^{2} L ( ρ ) = {P}_{0}^{- 1} + {\sum }_{i = 1}^{n} [ ∇ {\underline{e}}_{i}^{T} {S}_{i}^{- 1} ∇ {\underline{e}}_{i} + {∇}^{2} {\underline{e}}_{i} {S}_{i}^{- 1} {\underline{e}}_{i} ] .$$

Equation (9) above requires that the residual Jacobian ∇eᵢ and Hessian ∇²eᵢ be computed. While these equations have been omitted for brevity, they are well-known in the field and to a person of skill in the art. Such equations can be derived analytically or estimated using a finite-differences approach.

As the state ρ ₖ is updated based on new observations from the real-time process, the original path can be corrected online with a translational adjustment d_{cor} and a rotational adjustment R_{cor}, visualized previously in FIG. 4A, as

$${p}_{p , cor} = {p}_{p} + {d}_{cor} , \qquad ( 10 )$$

$${u}_{n , cor} = {R}_{cor} {u}_{n} ,$$

where the 2D vector d_{cor} describes a translation δd=[δx δy]^{T}, a rotation by θ, and a translation of δr along the admittance axis, as

$${\underline{d}}_{cor} = δ \underline{d} + ( {\underline{R}}_{θ} {\underline{p}}_{p} - {\underline{p}}_{p} ) - δ r {\underline{R}}_{θ} {\underline{p}}_{p} , \qquad ( 11 )$$

and the 3D vector d_{cor} results by projecting d_{cor} into 3D space as in Eqn. (4). The rotation matrix R_{cor} is similarly defined as the 3D projection of the 2D rotation matrix R_{θ}.

In applying the path corrections, it is necessary to apply a velocity correction term \dot{a}_{cor} to the admittance controller. Otherwise, the instantaneous path adjustments will be “felt” by the admittance controller and will result in undesirable forces applied to the part. By the chain rule, this velocity adjustment is

$${á}_{cor} = \frac{\partial a}{\partial t} = {( \frac{\partial a}{\partial ρ} )}^{T} ( \frac{\partial ρ}{\partial t} ) = ∇ {a}^{T} \dot{ρ} , \qquad ( 12 )$$

where, for a sample time tₛ, the speed \dot{ρ}=(ρₖ−ρₖ₋₁)/tₛ, and ∇α is computed by differentiating the projection of d_{cor} onto the corrected admittance axis R_{θ}uₙ as

$$\begin{matrix}∇ a = ∇ {( {\underline{R}}_{θ} {\underline{u}}_{n} )}^{T} {\underline{d}}_{cor} ) \\ = {[ ( {( {\underline{R}}_{θ} {\underline{u}}_{n} )}^{T} {( {\underline{{R}^{′}}}_{θ} {\underline{u}}_{n} )}^{T} ( δ \underline{d} - {p}_{p} ) - 1 ]}^{T} ,\end{matrix} \qquad ( 13 )$$

where

$${\underline{R}}_{θ}^{′} = \partial {\underline{R}}_{θ} / \partial θ$$

is the analytic derivative of R_{θ.}

It should be noted that, from this embodiment of the present invention, the covariance of the workpiece registration and tool, \tilde{P}, can be used to adaptively tune the admittance controller. This covariance matrix quantifies the uncertainty in the current state, given the “observations”, e.g., either the initial state or the residual samples. If we let z denote this set of generalized “observations”, then the state covariance can be computed by linearly projecting the observation covariance as

$$\tilde{P} = cov ( ρ ) = ( \partial ρ / \partial z ) cov ( z ) {( \partial ρ / \partial z )}^{T} . \qquad ( 14 )$$

While the observation covariances P₀ and Sᵢ are known, Eqn. (14) presents problems as the partial derivative term δρ/δz cannot be readily computed, and there exists only an implicit relationship between z and p defined by the optimization of L(ρ).

Using the Implicit Function Theorem and by judicious observations, Equation (14) can be simplified into the surprisingly elegant closed-form equation

$$\tilde{P} = {{[ {∇}^{2} L ( ρ ) ]}^{- 1} [ {P}_{0}^{- 1} + {\sum }_{i} ∇ {e}_{i}^{T} {S}_{i}^{- 1} ∇ {e}_{i} ] [ {∇}^{2} L ( ρ ) ]}^{- 1} , \qquad ( 15 )$$

where ∇²L(ρ) and ∇eᵢ are as defined above, and all quantities are computed using the current state estimate, ρₖ.

It should be clear that, for the method used for the admittance, the optimal behavior is to respond quickly when the part location is unknown, but to be slow and become more stable as the certainty of the registration improves. The online state covariance estimate \tilde{P} gives an ideal tool for this modulation. By projecting the state covariance onto the current admittance axis as

$${σ}_{a}^{2} = var ( a ) = ∇ {a}^{T} \tilde{P} ∇ a , \qquad ( 16 )$$

with ∇α as in Eqn. (13), we obtain

$${σ}_{a}^{2}$$

—the variance of the admittance axis itself. This projected quantity is ideal since it allows the admittance to be modulated based on the local admittance conditions rather than the global convergence of the state parameters. In other words, the admittance can be tuned based on knowledge of whether the admittance correction is known, rather than on whether the whole part has been localized. This distinction allows for ideal admittance behavior. The admittance controller is adaptively tuned with a scaling parameter γ_{α}, in the range 0-1, used in the modified controller

$$\ddot{a} = \frac{1}{{m}_{a}} [ {γ}_{a} ( {f}_{d} - f ) - {b}_{a} \dot{a} - {k}_{a} a ] , a = \int ( \int \ddot{a} dt - {\dot{a}}_{c o r} ) dt . \qquad ( 17 )$$

The scaling parameter γ_{α} should be computed from

$${σ}_{a}^{2} ,$$

according to the application. In one implementation, γ_{α} is computed according to the heuristic

$${γ}_{a} = 1 - ( 1 - {( {σ}_{a 0} / {σ}_{2 a} )}^{{j}_{a}} ) / ( 1 - {( {σ}_{a 0} / {σ}_{a , min} )}^{{j}_{a}} ) , \qquad ( 18 )$$

where δ_{α0} is the initial admittance standard error, δ_{α,min} is the minimum standard error (e.g., the error associated with no force control, and set according to the repeatability of the robot), and j_{α} is a tunable shape parameter. The result is then saturated within the range 0-1. While complex, this heuristic ensures that, as δ_{α0} approaches δ_{α,min}, γ_{α} tends from one to zero, and the admittance becomes increasingly damped.

The results from the above embodiment of the present invention can, however, be improved upon. Experiments and further implementations show that, by adjusting the various parameters and concepts of the present invention, the following advantages over not using the present invention can be achieved:
1. Faster cycle times & reduced costs: Lower required workpiece registration accuracy allows the use of lower cost and faster localization methods.
2. Improved machining quality & faster feedrates: Adaptive controller tuning ensures an optimal trade-off between edge tracking performance and controller stability, improving surface finish and allowing faster feedrates to be used effectively—further reducing cycle times.
3. Reduced tool wear: The present invention's improved contact stability reduces variability in the applied forces and notably reduces tool wear—significantly lowering the ongoing cost of machining tools for the workcell.
4. Improved process awareness & tool wear tracking: The present invention provides real-time registration covariance estimates and tool radius estimates, increasing process visibility and allowing tool wear to be tracked run-to-run.

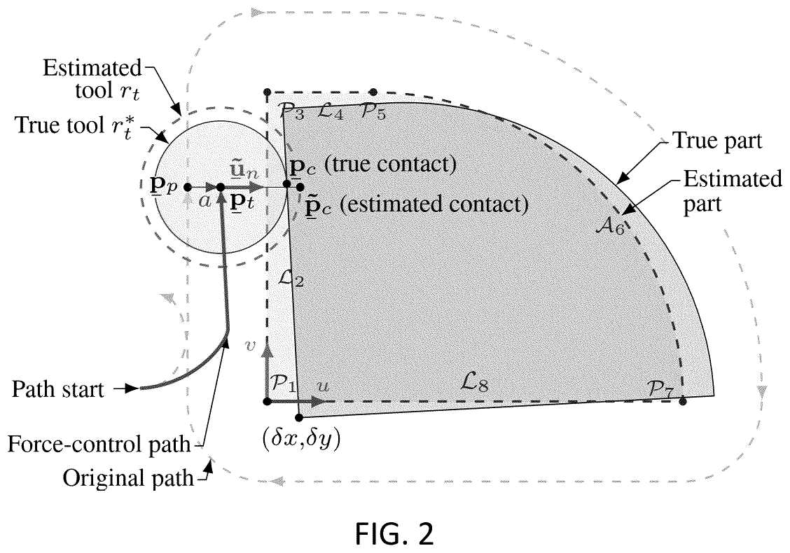

The embodiment of the present invention explained above relates to the robot machining of planar parts. An improved embodiment of the present invention can be characterized as relating to the optimal edge-tracking of a planar workpiece with uncertain registration. This improved embodiment takes into account tool wear and the variables and relationships are as shown in FIG. 2. As can be seen, the data shown in FIG. 2 is very similar to that in FIG. 3.

It should also be clear that, in the discussion below, some parts may be very similar to the discussion provided above. This is by design as the discussion below is an improvement on the embodiment of the present invention as detailed above.

As noted above, this embodiment of the present invention details optimal edge-tracking of a planar workpiece with uncertain registration. The associated frames and nomenclature are shown in FIG. 2. Let

$${T}_{p}^{*}$$

denote the homogeneous transformation matrix between the world and part frames, and let Tₚ denote a known estimate of this transform, obtained a priori via a vision system, jigging, or similar. The machining tool is modeled as a cylinder of radius

$${r}_{t}^{*} ,$$

and we let rₜ denote an initial, potentially poor estimate of this quantity. While machining, the tool radius will change due to tool wear with a proportionality constant

$${ψ}_{t}^{*} ,$$

and an initial estimate of this wear constant is ψₜ.

The geometry of the part is assumed to be available in terms of 2D primitive shapes, and it is assumed that a path allowing the tool to contour the part has been planned based on the estimated part location—as shown in dashed grey in FIG. 2. The workpiece geometry is constructed from a set of m primitive 2D entities, analogous to the DXF format commonly used in industry. In the current work, we consider three types of entity primitives: line elements, denoted as [symbol] arc elements, denoted as [symbol] and point elements, denoted as [symbol] for each j-th entity. The point elements do not contribute to the part periphery; however, they are useful in the current analysis for dealing with corner features. Many shapes can be decomposed into these primitives, with point elements inserted at each entity boundary. For example, the part in FIG. 2 is decomposed into four line elements, one arc element, and five point elements at each intersection. The contouring path consists of a time-series of 3D tool center target points pₚ, unit-length normal direction vectors uₙ, and commanded forces ƒ_{d}. As with the first embodiment of the present invention, a planning of such a path is well-known and may be found in the references noted above and may be accomplished using any number of CAD/CAM software packages.

As the robot contours the part, an admittance controller corrects for path errors by modifying the tool center from pₚ a distance α along uₙ to the corrected tool center pₜ, as

$${p}_{t} = {p}_{p} + a {u}_{n} , \qquad ( 1 A )$$

and attempts to maintain the desired normal force ƒ_{d} from the measured normal force ƒ according to the update law

$$\ddot{a} ( t ) = \frac{1}{{m}_{a}} [ {f}_{d} ( t ) - f ( t ) - {b}_{a} \dot{a} ( t ) - {k}_{a} a ( t ) ] , \qquad ( 2 A )$$

$$\dot{a} ( t ) = {\int }_{0}^{t} \ddot{a} ( τ ) d τ , a ( t ) = {\int }_{0}^{t} \dot{a} ( τ ) d τ ,$$

where m_{α}, k_{α}, and b_{α} are virtual mass-spring-damper coefficients that tune the “virtual suspension” of the controller.

As can be seen, Eqns. (1A) and (2A) are very similar to Eqns. (1) and (2) above.

The initial transform Tₚ comprises three unit vectors uₓₚ, u_{yp}, and u_{zp} and a displacement vector dₚ as

$${T}_{p} = [ \begin{matrix}{R}_{p} & {d}_{p} \\ 0 & 1\end{matrix} ] [ \begin{matrix}{u}_{x p} & {u}_{y p} & {u}_{z p} & {d}_{p} \\ 0 & 0 & 0 & 1\end{matrix} ] . \qquad ( 3 A )$$

For this embodiment of the present invention, workpieces are assumed planar, and we define the part plane πₚ from the xy plane of Tₚ such that

$${Π}_{p} = \{ p ∈ {ℝ}^{3} \vert p = {d}_{p} + u {u}_{x p} + v {u}_{y p} , u , v ∈ ℝ \} \qquad ( 4 A )$$

where p [symbol] [u v]^{T} describes the planar coordinates of the point p—noting that, as above, the underbar denotes 2D planar variables from their 3D counterparts. Projection of a point p∈ [symbol] ³ to a point p∈πₚ, and vice-versa, is accomplished as

$$\underline{p} = {[ \begin{matrix}{u}_{xp} & {u}_{yp}\end{matrix} ]}^{T} ( p - {d}_{p} ) , p = [ \begin{matrix}{u}_{xp} & {u}_{yp}\end{matrix} ] \underline{p} + {d}_{p} . \qquad ( 5 A )$$

Direction vectors are similarly converted, but without the translational shift of origin, dₚ.

Within the plane πₚ, the uncertainty in the workpiece registration, tool radius, and tool wear constant can be described using the five-element state vector

$$ρ = {[ \begin{matrix}δ x & δ y & θ & δ {r}_{t} & {δψ}_{t}\end{matrix} ]}^{T} , \qquad ( 6 A )$$

where δd [symbol] [δx δy]^{T} is a translational and θ is a rotational workpiece profile correction, δrₜ is a correction term for the tool radius, and δψₜ correction term for the tool wear constant. These states define the corrected part frame \tilde{T}ₚ,

$${\tilde{T}}_{p} = {T}_{p} [ \begin{matrix}{\underline{R}}_{θ} & 0 & δ \underline{d} \\ 0 & 1 & 0 \\ 0 & 0 & 1\end{matrix} ] , {\underline{R}}_{θ} = [ \begin{matrix}cos θ & - sin θ \\ sin θ & cos θ\end{matrix} ] , \qquad ( 7 A )$$

as well as the tool radius \tilde{r}ₜ=rₜ+δrₜ, and wear constant \tilde{ψ}ₜ=ψₜ+δψₜ. As with the explanation above, the tilde denotes the current variable estimate of a variable, transformed by ρ, while those without the tilde represent the initial estimate.

This embodiment of the present invention uses a controller that modifies the admittance relationship by allowing for real-time adaptation of the workpiece registration and of the tool radius to minimize the work required by the admittance controller. Simultaneously, an estimate of the registration quality is computed and used to modulate the tuning of the admittance force controller as required by current process conditions. FIG. 4C shows a diagram of the control architecture for this embodiment of the present invention. The desired force ƒ_{d}, target pose pₚ, and normal vector uₙ are provided by the path planner. A standard admittance controller modulates the target pose along the normal axis uₙ to maintain the target normal force ƒ_{d}. Simultaneously, an adaptation block records the tool centers pₜ and forces f while in contact with the part, and uses this information to update the system state estimate ρ, and to compute a path correction vector d_{cor}, a rotational correction matrix R_{cor}, and an admittance velocity correction term \dot{a}_{cor}. Finally, an admittance tuning parameter γ_{α} is calculated from an estimate of the state covariance. This parameter allows for the controller to behave rapidly before knowledge of the workpiece location is obtained and then allows the controller to then transition naturally to a damped controller as the registration improves.

The system of this embodiment of the present invention can be divided into nine major subsystems, as illustrated in FIG. 4D. As can be seen, this system 10 is almost identical to that illustrated in FIG. 4B, with the exception that this embodiment includes a wear tracker block 80A and an outlier detection block 80B. The system in FIG. 4D has a point accumulator block 20 that collects the incoming tool center and force measurements, pₜ and ƒ, to form a list of all registered data during the current run. The wear tracker block 80A uses measured forces to estimate tool wear, and similarly collects this data in a list. The contact model 30 estimates the workpiece-tool contact points pp_{ci} for each observation. The CAD matching system 40 takes the estimated tool contact points \tilde{p}p_{ci} and matches them to their estimated corresponding points on the CAD model, pₘᵢ. These matched points can be compared with the contact points \tilde{p}_{ci} to produce a set of residual vectors eᵢ, which are used to compute weights wᵢ in the outlier detection system 80B. The iterative refinement block 50 computes appropriate updates to the state estimate to minimize squared residual error. The path correction system 60 computes the path adjustment terms d_{cor}, R_{cor}, and \dot{a}_{cor}. Finally, the covariance estimation system 70 computes the estimated state covariance P, and the admittance tuning block 80 projects this covariance onto the admittance axis to produce a tuning factor γ_{α} to modulate the admittance behavior based on the certainty of the path estimate. It should be clear that, where the subsystems of this embodiment are the same as the subsystems in the embodiment illustrated in FIG. 4B, details regarding the description, behavior, and implementation of such similar subsystems have been omitted. The subsystems that do not overlap for FIG. 4B and FIG. 4D are described in detail below as necessary.

The wear tracker block 80A seeks to model tool wear in real-time using the measured forces ƒ. While multiple models and approaches have been used to model tool wear, for this embodiment of the present invention, the wear model need only be accurate within the repeatability of the robotic manipulator, since toolpath accuracy will not improve past this level. Furthermore, part thickness, material and tool velocity are constant. Thus, a much simpler model can be used. The rate of change of the tool radius as proportional to the positive exponentiated applied force, is modeled as

$$δ {\dot{r}}_{t , wear} = {{\tilde{ψ}}_{t} ( {f}_{i} {{\int }_{0}}^{∞} )}^{{j}_{t}} , \qquad ( 8 A )$$

where \tilde{ψ}ₜ is the estimated tool wear constant and jₜ is a shape parameter capturing the nonlinearity of the wear relationship. The symbol

$${{\int }_{0}}^{∞}$$

denotes saturation between 0 and ∞, since negative interaction forces do not cause negative tool wear. Thus, at a given time tᵢ during the test, the tool radius correction due to wear is δr_{t,wear}=\tilde{ψ}ₜΦₜᵢ, where Φₜᵢ is an integrated force term, approximated with a sample rate Fₛ as

$${Φ}_{ti} {=}^{Δ} {\int }_{0}^{{τ}_{i}} {( f ( t ) )}^{{j}_{t}} dt \approx \frac{1}{{F}_{s}} {\sum }_{k = 1}^{\text{?}} {( {f}_{k} )}^{{j}_{t}} \qquad ( 9 A )$$

$$\text{?} \text{indicates text missing or illegible when filed}$$

The forces ƒₖ must be lowpass filtered before integration to remove frequency content higher than those representing actual mechanical part interactions. Appropriate estimates of the model parameters ψₜ and jₜ can be found via offline testing. To accommodate for manufacturing differences in individual tools and ensure optimal path accuracy, we include the wear constant \tilde{ψ}ₜ in the state vector ρ, and allow it to be adapted in real-time based on observed data. However, it is deemed unnecessary to similarly allow for changes in the shape parameter jₜ. The applied force ƒ is generally constant, and thus jₜ is mostly unobservable—without changes in ƒ, it is not possible to differentiate between a change in jₜ and a change in \tilde{ψ}ₜ. Thus, while jₜ is included to more accurately track wear, it is of little benefit to adapt it online.

If there are out-of-plane errors in part registration, the wear model may be inconsistent as the workpiece-tool contact shifts axially, causing wear at various tool points. However, often the part plane is constant, so accurate calibration is possible. Otherwise, dithering the tool along the spindle axis can reduce the required accuracy, while also extending tool life.

For the contact model block 30, this embodiment of the present invention takes into account the tool wear and, as such, the model used in the previous embodiment will need correction. For this contact model block 30, the block 30 converts each of the n measured tool positions pₜᵢ and forces ƒᵢ into corresponding estimated workpiece-tool contact points, p_{ci}. The simple compliance model used for this estimation is shown in FIG. 5B, imagining a spring of constant kₜ between the workpiece and tool, while incorporating the radius correction δrₜ and the wear correction \tilde{ψ}ₜ Φₜᵢ. Thus, an estimate of the contact point is

$${\tilde{\underline{p}}}_{ci} = {\tilde{\underline{p}}}_{ti} + {r}_{t , cor} {\tilde{\underline{u}}}_{ni} \qquad ( 10 A )$$

where the corrected tool radius is

$${r}_{t , cor} = {r}_{t} + δ {r}_{t} - {\tilde{ψ}}_{t} {Φ}_{ti} - {f}_{i} / {k}_{t} , \qquad ( 11 A )$$

and \tilde{e}ₙᵢ is the estimated normal axis, after rotation by the current rotational state θ as ũₙᵢ=\tilde{R}_{θ}uₙᵢ.

For this embodiment, the tool stiffness kₜ is a lumped stiffness term that includes tool compliance, as well as the compliance of the robot itself. Thus, even rigid tools will have associated compliance. The stiffness term can be found via offline testing. Similar to the wear shape parameter jₜ, the stiffness kₜ is not included in the real-time state estimate ρ. With a relatively constant force ƒ, it is not possible to differentiate between changes in the tool stiffness kₜ and changes in the tool radius δrₜ, since each act collinearly in the estimation of \tilde{p}_{ci}. Thus, small inaccuracies in the estimate of kₜ do not notably affect the method. Additionally, it was observed experimentally that kₜ does not change significantly with tool wear, and can be considered fixed for a given tool type.

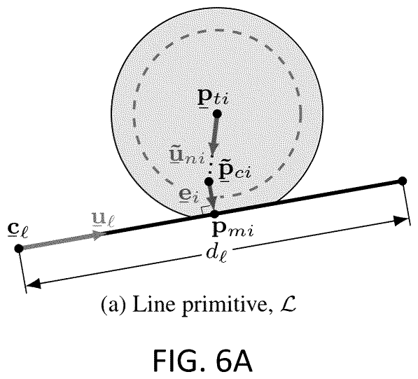

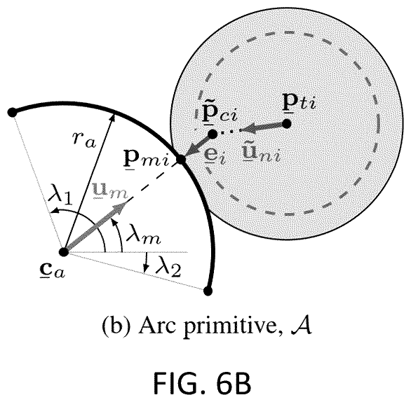

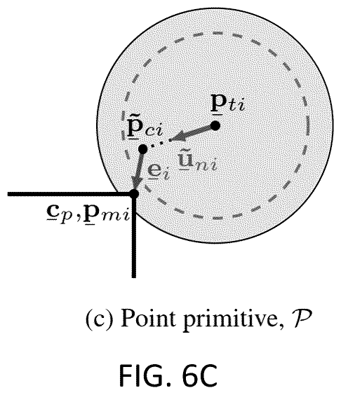

The next step in the method for this embodiment of the present invention is to match each of the estimated contact points \tilde{p}_{ci} to an estimate of their corresponding points on the CAD profile, denoted as pₘᵢ. First, the CAD entities ε must be updated according to the current state estimate ρₖ to give the estimated CAD entities \tilde{ε}. Then, correspondences are determined as the point on \tilde{ε} closest to the contact point \tilde{p}_{ci}. This process is shown in FIG. 6A, FIG. 6B, and FIG. 6C and depends on the entity type: line, arc, or point.

If the j-th entity is a line element, then we label its original position [symbol] and parameterize it as in FIG. 6A, with a starting point [symbol] , a unit-length direction vector [symbol] , and a line distance [symbol] . This entity is transformed by the state estimate ρₖ to the estimated entity [symbol] with parameters

$${\tilde{\underline{c}}}_{ℓ} = {\underline{R}}_{θ} {\underline{c}}_{ℓ} + δ \underline{d} , {\underline{u}}_{ℓ} = {\underline{R}}_{θ} {\underline{u}}_{ℓ} \qquad ( 12 A )$$

The closest point pₘᵢ is given by projecting \tilde{p}_{ci} onto [symbol] as

$${\begin{matrix}{\underline{p}}_{mi} = {\tilde{\underline{c}}}_{ℓ} + α {\tilde{\underline{u}}}_{ℓ} , & α = {{\tilde{\underline{u}}}_{ℓ}}^{T} ( {\tilde{\underline{p}}}_{c} - {\tilde{\underline{c}}}_{ℓ} ) / {d}_{ℓ}\end{matrix}}^{2} . \qquad ( 13 A )$$

The intermediate vector α is a number from 0 to 1, indicating the relative position of pₘᵢ along the line. If α is outside of this range, the matched point is not on the line, and the closest point to \tilde{p}_{ci} must lie on a different entity or the endpoints of the line, each represented by a separate point entity.

If the j-th entity is an arc element, we label its original position [symbol] and parameterize it as in FIG. 6B, with an arc center c_{α}, radius r_{α}, and start and end angles λ₁ and λ₂, respectively. This entity is transformed by ρₖ to the estimated entity [symbol] as

$$\begin{matrix}{\tilde{\underline{c}}}_{a} = {\tilde{\underline{R}}}_{θ} {\underline{c}}_{a} + δ \underline{d} , & {\tilde{λ}}_{1} = {λ}_{1} + θ , & {\tilde{λ}}_{2} = {λ}_{2} + θ .\end{matrix} \qquad ( 14 A )$$

The closest point \tilde{p}ₘᵢ on [symbol] to \tilde{p}_{ci} is given by

$${\underline{p}}_{mi} = {\tilde{\underline{c}}}_{a} + {r}_{a} {\tilde{\underline{u}}}_{m} , \qquad ( 15 A )$$

where the unit direction vector ũₘ is obtained by normalizing the direction vector \tilde{v}ₘ between \tilde{p}_{ci} and the arc center \tilde{c}_{α},

$$\begin{matrix}{\tilde{\underline{u}}}_{m} = \frac{{\tilde{\underline{v}}}_{m}}{‖ {\tilde{\underline{v}}}_{m} ‖} , & {\tilde{\underline{v}}}_{m} = {\tilde{\underline{p}}}_{ci} - {\tilde{\underline{c}}}_{a} .\end{matrix} \qquad ( 16 A )$$

This closest point will make an angle \tilde{λ}ₘ=∠ũₘ with the center of the arc, which must be between the arc bounds \tilde{λ}₁ and \tilde{λ}₂. Otherwise, the closest point is on a different entity or the arc's endpoints.

Finally, if the j-th entity is a point element, we label its original position as [symbol] . A point is parameterized as in FIG. 6C with the single 2-vector cₚ, and is transformed by ρₖ to the estimate entity [symbol] with

$${\tilde{\underline{c}}}_{p} = {\underline{R}}_{θ} {\underline{c}}_{p} + δ \underline{d} . \qquad ( 17 A )$$

In all cases, the closest point pₘᵢ is simply equal to \tilde{c}ₚ.

Once the closest point to each j-th entity, labeled as pₘᵢⱼ, has been computed, it suffices to return the one that minimizes the Euclidean distance to \tilde{p}_{ci} over each of the m entities,

$$\begin{matrix}{\underline{p}}_{mi} = arg {min}_{{\underline{p}}_{mij} , j = 1 , … , m} & ‖ {\tilde{\underline{p}}}_{ci} - {\underline{p}}_{mij} ‖ .\end{matrix} \qquad ( 18 A )$$

The set of n estimated contact points \tilde{p}_{ci} and their correspondences on the estimated workpiece profile, pₘᵢ, can now be readily used to refine the workpiece registration. Refinement is accomplished as an optimization, iteratively minimizing the nonlinear quadratic cost function

$$L ( ρ ) = \frac{1}{2} {ρ}^{T} {P}_{0}^{- 1} ρ + \frac{1}{2} {\sum }_{i = 1}^{n} {w}_{i} {{\underline{e}}_{i}}^{T} {S}_{i}^{- 1} {\underline{e}}_{i} , \qquad ( 19 A )$$

where eᵢ is the error residual vector shown in FIG. 6A, FIG. 6B, and FIG. 6C,

$${\underline{e}}_{i} = {\tilde{\underline{p}}}_{ci} - {\tilde{\underline{p}}}_{mi} , \qquad ( 20 A )$$

and P₀∈ [symbol] ⁵⁻⁵ is the positive definite initial state covariance matrix, describing the accuracy of the poor initial registration estimate, Sᵢ∈ [symbol] ^{2×2} is a positive definite matrix describing the covariance of the i-th measurement pₜᵢ, and wᵢ is a weighting factor used for outlier detection.

This cost function contains two quadratic terms. The first term acts as an L₂ regularization term, drawing the solution towards the initial state estimate in the absence of better data, and weighted by the reciprocal of the known initial covariance P₀. The second term seeks to minimize the squared error of the residual vectors—again weighted by the reciprocal of covariance Sᵢ. Weighting each term by their reciprocal covariance ensures that the resulting estimate is optimal, in the sense of minimizing the variance of all information sources. Iterative refinement of the cost function L(ρ) is accomplished with a second-order Newton step at each time step, ρₖ=ρₖ₋₁+δρ. We seek to satisfy the first-order optimality condition ∇L(ρ)=0. A Taylor-series expansion of this condition from a perturbation δρ is

$$∇ L ( ρ + δρ ) \approx ∇ L ( ρ ) + {∇}^{2} L ( ρ ) δρ = 0. \qquad ( 21 A )$$

Rearrangement of Eqn. (21A) gives an estimate of the optimal step

$$δρ = - {[ {∇}^{2} L ( ρ ) ]}^{- 1} ∇ L ( ρ ) = - {H ( ρ )}^{- 1} g ( ρ ) , \qquad ( 22 A )$$

where g(ρₖ)∈ [symbol] ⁵ and H(ρₖ)∈ [symbol] ⁵⁻⁵ are the optimization gradient and Hessian, respectively, and are computed as

$$\begin{matrix}g ( ρ ) = {P}_{0}^{- 1} ρ + {\sum }_{i = 1}^{n} {w}_{i} ∇ {\underline{{e}_{i}}}^{T} {S}_{i}^{- 1} {\underline{e}}_{i} , \\ H ( ρ ) = {P}_{0}^{- 1} + {\sum }_{i = 1}^{n} {w}_{i} [ ∇ {\underline{{e}_{i}}}^{T} {S}_{i}^{- 1} ∇ {\underline{e}}_{i} + {∇}^{2} {\underline{e}}_{i} {S}_{i}^{- 1} {\underline{e}}_{i} ] .\end{matrix} \qquad ( 23 A )$$

The first-order partial derivative terms of the residuals ∇eᵢ are 2×5 matrices, and the second-order partial derivatives ∇²eᵢ are 2×5×5 tensors, with the multiplication of ∇²eᵢ in Eqn. (23A) performed via a tensor contraction along the first dimensions of ∇²eᵢ and

$${S}_{i}^{- 1} {\underline{e}}_{{}^{i}} .$$

Equations to compute ∇eᵢ and ∇²eᵢ are required to implement this embodiment of the present invention. The derivation of these equations in full can be found in the Appendix of Reference [5].

The update scheme in Eqn. (22A) is highly efficient. As a pure Newton update, it converges quadratically once near a solution. Practically, this equation converges rapidly from poor initial state estimates to within robot tolerances in only two or three iterations. While efficient convergence is desirable, overly fast convergence could apply path corrections faster than the robot can respond. Simply saturating the state updates δ can destabilize the convergence. A more stable solution is to dampen the update equations as

$${ρ}_{k + 1} = {ρ}_{k} - {[ H ( {ρ}_{k} ) + diag λ ]}^{- 1} g ( {ρ}_{k} ) , \qquad ( 24 A )$$

where λ is a 5-vector of positive damping factors for each state. This change has the effect of adding to the cost function L(ρ) an additional quadratic term (δρ^{T}diagλδρ), penalizing large rates of change in ρ. Moreover, this addition has the advantage of helping to ensure that the inverted matrix in Eqn. (24A) remains positive definite, increasing algorithm stability.

Like all least-squares problems, the cost function L(ρ) can be sensitive to outliers. Because the squared error

$${\underline{e}}_{i}^{T} {S}_{i}^{- 1} {\underline{e}}_{{}^{i}}$$

is very large for an outlier sample, the presence of only a few outliers can significantly skew the registration results. In the case of the present invention, outlier detection is critical since anomalous points regularly arise from two main sources. Firstly, burrs, scallops, or imperfections in the workpiece profile can cause the tool to deviate from the true part periphery and record erroneous points, which should be omitted from the analysis. Secondly, the contact model described above can give poor results near workpiece complexities such as corners or pockets. In these situations, the workpiece features may be smaller than the tool, and the side of the tool can contact the workpiece prior to the point along the normal vector uₙ. This situation is illustrated in FIG. 5B, where the right side of the tool contacts the workpiece earlier than expected due to the rotational error in the path, and thus the estimated contact point \tilde{p}_{ci} is slightly off from the true contact point p_{ci}. Without outlier detection, outliers would skew the results enough to notably reduce the algorithm's effectiveness.

However, this embodiment of the present invention uses an online identification routine, so outlier detection must be done carefully. As information is gathered, newer data points contain novel information, which may disagree with the current consensus and cause these points to be incorrectly categorized as outliers. When this happens, learning is delayed, and the method can malfunction.

To resolve this issue, we define two weighting schemes—one to identify outliers based on probabilistical distance, with weights w_{di}, and another to identify novel points and protect them from the outlier detection, with weights wₜᵢ. The weights, in the range 0-1, are combined using probabilistic “OR” logic, such that the point is included if either w_{di} or wₜᵢ are large,

$${w}_{i} = 1 - ( 1 - {w}_{d i} ) ( 1 - {w}_{ti} ) . \qquad ( 25 A )$$

The weights w_{di} are determined by analyzing the residuals eᵢ and excluding probabilistically unlikely points. This analysis is accomplished by assuming the residuals eᵢ approximately follow a multivariate normal distribution of mean μₑ and covariance Σₑ as

$${μ}_{e} = \frac{1}{n} {\sum }_{i = 1}^{n} {\underline{e}}_{{}^{i}} , {\sum }_{e} = \frac{1}{n} {\sum }_{i = 1}^{n} ( {\underline{e}}_{{}^{i}} - {μ}_{e} ) {( {\underline{e}}_{{}^{i}} - {μ}_{e} )}^{T} . \qquad ( 26 A )$$

For each sample, the Mahalanobis distance is

$${d}_{m i} = \sqrt{{( {\underline{e}}_{{}^{i}} - {μ}_{e} )}^{T} {{\sum }_{e}^{- 1}}_{{}^{}} ( {\underline{e}}_{{}^{i}} - {μ}_{e} )} \qquad ( 27 A )$$

and can be interpreted as a multi-dimensional generalization of how many (the number of) standard deviations per sample to the mean. A consensus is defined by thresholding points based on their Mahalanobis distance dₘᵢ using a logistic sigmoid function

$${w}_{d i} = {( 1 + {e}^{4 ( {d}_{m i} - {b}_{d} ) / {a}_{d}} )}^{- 1} , \qquad ( 28 A )$$

where α_{d} and b_{d} are tuning factors that determine the steepness and center of the thresholding, respectively, both in units of number of standard deviations, and the number 4 simply scales the slope of the sigmoid function such that 96% of the threshold transition happens within a distance α_{d}. Other scaling factors for the slope of the sigmoid functions may be used.

For time-based weights, the goal is to ensure that novel points are not identified as outliers. We define the age of the point as δtᵢ=−tᵢ, where t is the current process time, and tᵢ is the time the point was gathered. The age is then thresholded as before

$${w}_{ti} = {( 1 + {e}^{4 ( δ {t}_{i} - {b}_{t} ) / {a}_{t}} )}^{- 1} , \qquad ( 29 A )$$

where αₜ and bₜ set the steepness and center of the threshold.

As noted above, the probabilistic “OR” logic is used to combine w_{di} and wₜᵢ. The overall weight wᵢ is high if either w_{di} or wₜᵢ is high—that is, a point is included if it is not an outlier or if it is a recently obtained point.

As ρ is updated during machining, the original path is corrected in real-time, as visualized in FIG. 4C, with

$${p}_{p , c o r} = {p}_{p} + {d}_{cor} , {u}_{n , c o r} = {R}_{c o r} {u}_{n} . \qquad ( 30 A )$$

The 2D vector d_{cor} comprises corrections due to a translation δd, a rotation θ, and a radius-correcting translation along ũₙ,

$${\underline{d}}_{{}^{cor}} = δ \underline{d} + ( {\underline{R}}_{{}^{θ}} {\underline{p}}_{{}^{p}} - {\underline{p}}_{{}^{p}} ) + ( {r}_{t} - {r}_{t , cor} ) {\underline{R}}_{{}^{θ}} {\underline{u}}_{{}^{n}} . \qquad ( 31 A )$$

The 3D vector d_{cor} can be computed from d_{cor} with a coordinate conversion from planar space, as in Eqn. (5A). Lastly, R_{cor} is defined by a rotation of θ about u_{zp}, computed as

$${R}_{c o r} = {R}_{p} [ \begin{matrix}{\underline{R}}_{{}^{θ}} & 0 \\ 0 & 1\end{matrix} ] {R}_{p}^{T} . \qquad ( 32 A )$$

In correcting the path, it is necessary to apply a velocity adjustment term \dot{a}_{cor} to the admittance controller. Otherwise, the speed of the path adjustments from Eqn. (3A) will be “felt” by the controller, causing undesirable force fluctuations and destabilizing the force controller. The velocity adjustment term can be computed by leveraging the chain rule as

$${\dot{a}}_{c o r} = \frac{\partial a}{\partial t} = {( \frac{\partial a}{\partial ρ} )}^{T} ( \frac{\partial ρ}{\partial t} ) = ∇ {a}^{{}_{T}} \dot{ρ} , \qquad ( 33 A )$$

where for a sample rate Fₛ,

$$\dot{ρ} = {F}_{s} ( {ρ}_{k} - {ρ}_{k - 1} ) = {F}_{s} δρ , \qquad ( 34 A )$$

and ∇π can be computed by differentiating d_{cor} after projecting it onto the corrected admittance axis R_{θ}uₙ as

$$∇ a = ∇ ( {( {\underline{R}}_{θ} {\underline{u}}_{n} )}^{T} {\underline{d}}_{c o r} ) = {[ \begin{matrix}{( {\underline{R}}_{θ} {\underline{u}}_{n} )}^{T} & {( {\underline{R}}_{θ}^{′} {\underline{u}}_{n} )}^{T} ( δ \underline{d} - {\underline{p}}_{p} ) & \text{-1} & {Φ}_{tk}\end{matrix} ]}^{T} , \qquad ( 35 A )$$

where

$${R}_{θ}^{′}$$

is the analytic derivative of R_{θ} with respect to θ.

For the state covariance estimation, this embodiment of the present invention takes into account outlier detection. Accordingly, with the Hessian H as defined in Eqn. (23A), the closed-form estimate of state covariance is given as

$$\tilde{P} = {H}^{- 1} [ {P}_{0}^{- 1} + {\sum }_{i = 1}^{n} {w}_{i}^{2} ∇ {{e}_{–}}_{i}^{T} {S}_{i}^{- 1} ∇ {{e}_{–}}_{i} ] {H}^{- 1} , \qquad ( 36 A )$$

All quantities are computed with the current state, ρₖ. This can be contrasted with the closed-form estimate of state covariance for the previous embodiment as detailed in Eqn. (15) above.

For admittance controller adaptation, this embodiment of the present invention is very similar to that given and discussed for the previous embodiment detailed above. As with the previous embodiment, the optimal behavior of the admittance method is to respond quickly, with low damping, when the part location is unknown, but more stable as certainty of the workpiece edge improves. The online state covariance estimate \tilde{P} gives an ideal tool for this modulation. However, we are not interested in the variance of individual states—rather, we wish to know the certainty of the estimate of the admittance distance α, as quantified by the variance

$${σ}_{a}^{2} .$$

This variance is computed by projecting the covariance \tilde{P} onto the current normal axis, as

$${σ}_{a}^{2} = var ( a ) = ∇ {a}^{T} \tilde{P} ∇ a , \qquad ( 37 A )$$

where ∇α is computed as in Eqn. (35A). The variance

$${σ}_{a}^{2}$$

is a useful quantity since it allows the method of the present invention to adapt the admittance tuning according to the local rather than global uncertainty conditions. An example of this behavior is when the tool initially contacts the part along an edge. The algorithm will locate that edge, but it will not know if the errors are due to translational registration error or an incorrect tool radius—without data from multiple perspectives of the part, these two sources of error are collinear and unobservable. However, this collinearity is quantified by the state covariance estimate \tilde{P}, and when projected along this same axis, the admittance variance

$${σ}_{a}^{2}$$

will be low, which is the desired result.

Adaptation of the admittance controller is done via a scaling parameter γ_{α}, in the range 0-1, which is used in the modified admittance force controller shown in FIG. 4D,

$$\ddot{a} ( t ) = \frac{1}{{m}_{a}} [ {f}_{d} ( t ) - f ( t ) - \frac{{b}_{a}}{{γ}_{a}} \dot{a} ( t ) - {k}_{a} a ( t ) ] , \qquad ( 38 A )$$

$$\begin{matrix}\dot{a} ( t ) = {\int }_{0}^{t} \ddot{a} ( τ ) d τ , & a ( t ) = {\int }_{0}^{t} ( \dot{a} ( τ ) - {\dot{a}}_{c o r} ( τ ) ) d τ\end{matrix} .$$

This controller is similar to the original admittance controller in Eqn. (2A), but the damping is modulated by the scaling parameter γ_{α}. Note that this adaptation scheme is updated slightly from scheme presented above in relation to the previous embodiment. However, this scheme has been adjusted to give better contact stability-for this embodiment, the mass ma and spring constant k_{α} were also modulated. However, experimental testing showed that better results could be achieved with constant mass and spring, and modulating only the damping based on registration accuracy. Because γ_{α} is in the range 0-1, the effective damping b_{α}/γ_{α} of the controller can only increase. Thus, if the originally nominal admittance gains are safe, any value of γ_{α} will only slow down the system further, essentially tuning it asymptotically into a pure position controller as registration certainty improves.

The scaling parameter γ_{α} should be calculated from

$${σ}_{a}^{2}$$

based on the application to give reasonable values. In the current work, we propose the heuristic

$${γ}_{a} = 1 - \frac{1 - {( {σ}_{a 0} / {σ}_{a} )}^{{j}_{a}}}{1 - {( {σ}_{a 0} / {σ}_{a , min} )}^{{j}_{a}}} , \qquad ( 39 A )$$

where δ_{α0} is the initial admittance standard error, which can be estimated by substituting P₀ into Eqn. (37A); δ_{α,min} is the minimum standard error, i.e., the error associated with no force control, and be set to approximately the repeatability of the robot; and jₐ is a tunable shape parameter, with jₐ=0.5 being a reasonable starting estimate. Lastly, the value of γ_{α} is saturated between a lower bound γ_{α,min} and one to ensure safe behavior of the controller. While complex, this heuristic ensures that as δ_{α} approaches δ_{α,min}, the tuning γ_{α} tends from one to zero, and the admittance becomes increasingly damped, in a way that was found to give good behavior in physical testing.

The above embodiments of the present invention can, however, still be improved upon to provide even better results. More specifically, experiments have shown that, while the above embodiments of the present invention are effective, the machining of the workpiece can be further optimized such that, at least for a deburring task, burrs are removed more effectively. Adjustments to the present invention allow for, when the machining task is deburring, the identification and removal of large burrs, scallops, and index tabs on the workpiece. As well, these adjustments can more effectively remove large imperfections on the workpiece, improve controller contact stability, and optimize cycle times.

It should be clear from the above discussion that the present invention monitors the measured robot position q and tool forces ƒ and attempts to improve the registration estimate of the part while adaptively tuning the admittance controller for optimal performance. The system of the present invention outputs four key terms:
1. d_{cor}, a path correction term based on an improved estimate of the workpiece location and tool size,
2. R_{cor}, a rotational correction term for the orientation of the normal vector uₙ, based on an improved estimate of the workpiece rotation,
3. γ_{α}, an adaptive tuning factor in the range 0-1, which represents the quality of the algorithm's estimate of the workpiece location, projected onto the current normal axis uₙ. When γ→1, the uncertainty of the path correction a is high, and when γ→0, the uncertainty is low,
4. \dot{a}_{cor}, a velocity correction term applied in the admittance controller to compensate for changes in the path correction terms d_{cor} and R_{cor}.

The admittance controller defines the dynamic relationship between positional and force error to maintain the desired contact force ƒ_{d} by modifying the commanded tool center a distance α along the corrected normal axis ũ_{n,cor}, as shown in FIG. 5B, as

$${p}_{c m d} = {p}_{p} + a {\tilde{u}}_{n , c o r} + {d}_{c o r} , {\tilde{u}}_{n , c o r} = {R}_{cor} {u}_{n} , \qquad ( 1 B )$$

where α is computed with mass m_{α}, spring constant k_{α}, and damping dynamically modulated as b_{α}/γ_{α}, such that

$$\begin{matrix}\ddot{a} = \frac{1}{{m}_{a}} [ {f}_{d} - f - \frac{{b}_{a}}{{γ}_{a}} \dot{a} - {k}_{a} a ] , & a = \int ( {\dot{a}}_{c o r} + \int \ddot{a} d t ) d t .\end{matrix} \qquad ( 2 B )$$

When the part registration is poor, γ_{α}≈1, the effective damping is low, and the controller can move quickly to locate workpiece edges. However, as the localization improves, γ_{α}→0, the damping increases, and the controller is slowed for better contact stability.

This third embodiment of the present invention adjusts the previous embodiments by
1. Modifying the admittance adaptation method to penalize positional deflections when part registration is good, thereby allowing for more complete removal of burrs, and
2. Introducing a feedrate modulation technique to more effectively remove large workpiece imperfections, improve controller contact stability, and optimize cycle times.

The following discussion below details these adjustments.

As should be clear, the present invention may be used for many machining tasks. When it comes to deburring, large burrs, scallops, index tabs, and other imperfections should be removed from the part edge. Unfortunately, complete removal of these imperfections can be challenging. Even larger burrs are small compared to the typical path accuracy of the manipulator, and without knowledge of the workpiece geometry, a nominal force-controlled deburring process cannot differentiate between a workpiece imperfection and the workpiece itself. However, the present invention offers two key advantages. First, the path error is reduced to negligible levels almost immediately once machining begins, enabling the detection and rejection of scallops and burrs. Second, the tuning parameter γ_{α} provides a reliable estimate of the current path accuracy. If the tool encounters an obstacle in the path and the path is estimated to be accurate, e.g., γ_{α}→0, we can reasonably conclude that the obstacle is a workpiece imperfection that should be removed.

To improve the performance of the system of the present invention, a modification to the admittance update equation from Eqn. (2B) above can be applied. While the admittance adaptation term γ_{α} was previously used only to modulate virtual damping as b_{α}/γ_{α}, the virtual stiffness can be additionally modulated as

$$\ddot{a} = \frac{1}{{m}_{a}} [ {f}_{d} - f - \frac{{b}_{a}}{{γ}_{a}} \dot{a} - \frac{{k}_{a}}{{γ}_{a}^{[ {j}_{k} 1 ( - a ) ]}} a ] , \qquad ( 3 B )$$

where jₖ is a tunable shape parameter, and the Heaviside function 1(⋅) returns one when its input is positive and zero otherwise. Thus, the effective spring constant is k_{α} when the admittance correction a is positive, and k_{α}/γ_{α}^{jk} otherwise. When the path estimate is poor, k_{α} must be tuned to a small, negligible value. Otherwise, the force controller would be discouraged from leaving the nominal, low-accuracy path, and result in poor edge-tracking. With the scheme defined in Eqn. (3B), this behavior is retained: if the path estimate is poor, γ_{α}≈1, and thus k_{α}/γ_{α}^{jk}≈k_{α}. However, when the path estimate is good, we can penalize path deviations by setting k_{α} much higher. By dividing by k_{α}/γ_{α}^{jk} as γ→>0, k_{α} becomes large. The parameter jₖ allows for more precise adaptation tuning based on the application, relative to the damping modulation b_{α}/γ_{α}.

Different behaviors may be desired depending on whether the admittance correction α is positive or negative. If α is negative, it indicates that the tool has moved outwards from the nominal path, and has likely encountered a burr, scallop, or other imperfection that should be removed. Thus, a large spring constant is ideal to prevent the tool from deflecting around the obstacle, and to fully remove it instead. However, if α is positive, indicating that the tool has moved inwards from the nominal path, then the tool is following a pocket in the workpiece periphery. Although such a deviation of the part periphery is undesirable, the ideal outcome is to ensure that the edge inside this pocket is deburred appropriately. Thus, the desired behavior is to have a low spring constant, allowing the tool to deflect to follow the edge, despite the deviation. Including the Heaviside term 1(−α) in the exponent of γ_{α} in Eqn. (3B) accomplishes this logic when a is positive by resetting the effective spring constant to be k_{α}/γ_{α}⁰=k_{α}.

One potential downside of the above modification is that the contact force may increase substantially when encountering obstacles. However, this issue can be addressed by modulating the real-time feedrate (i.e. the speed at which the tool travels or traverses the contour of the workpiece). This is explained in more detail below.

The other modification to the present invention is to modulate the tool feedrate based on process conditions. This modification offers many advantages for precision robotic deburring applications. First, modulating the feedrate can improve cycle times. With constant feedrate, a conservative speed must be selected, dictated by the largest burrs or scallops on the part. By modulating the feedrate, more time can be spent on areas with greater need, and faster feedrates used otherwise. Second, feedrate modulation can enhance contact stability. There are situations where the tool loses contact with the part or applies excessive force. If the feedrate is held constant, sections of the workpiece may be unprocessed (in the case of contact loss) or damaged (in the case of over-force). Modulating the feedrate can slow the tool, giving the force controller more time to stabilize on the workpiece edge and avoid potential contact-loss or over-force errors. Finally, with the spring constant modulation adjustments detailed above, the tool will avoid deflecting around large workpiece imperfections such as burrs, scallops, or index tabs. Instead, the tool will push through the imperfection to remove it entirely. Unfortunately, this strategy, combined with a constant feedrate, causes the contact force to increase drastically, resulting in excessive tool wear. Moreover, the tool will only spend a short time on the burr, which may be insufficient to fully remove it. By adaptively slowing the feedrate, the force can be held more constant, and the tool will spend more time on the imperfection, removing it more effectively.

The feedrate modulation strategy depends on two main factors: the measured normal contact force error, ƒₑᵣᵣ=ƒ−ƒ_{d}, and the accuracy of the path, as estimated by the admittance adaptation parameter, γ_{α}. The desired feedrate logic is as follows:
1. If the desired force is too low, then the tool has lost contact with the part. In this case, the feedrate should be slowed to allow the force controller to find the workpiece again without leaving unprocessed sections of the edge.
2. If the desired force is too high, then:
(a) If the path accuracy is poor, i.e., γ_{α}≈1, then the tool is attempting to move into the part due to path error. In this case, the feedrate should be slowed to allow the force controller to move away from the part and stabilize the contact.
(b) If the path accuracy is good, i.e., γ_{α}≈0, then the tool is in contact with an obstacle but will not move around it because of the logic from the above spring rate modulation. In these cases, the feedrate must also be slowed to lower the contact force while fully removing the workpiece imperfection.

Thus, despite various situations leading to changes in ƒₑᵣᵣ, the solution always involves decreasing the feedrate when the force error magnitude increases, regardless of γ_{α}.

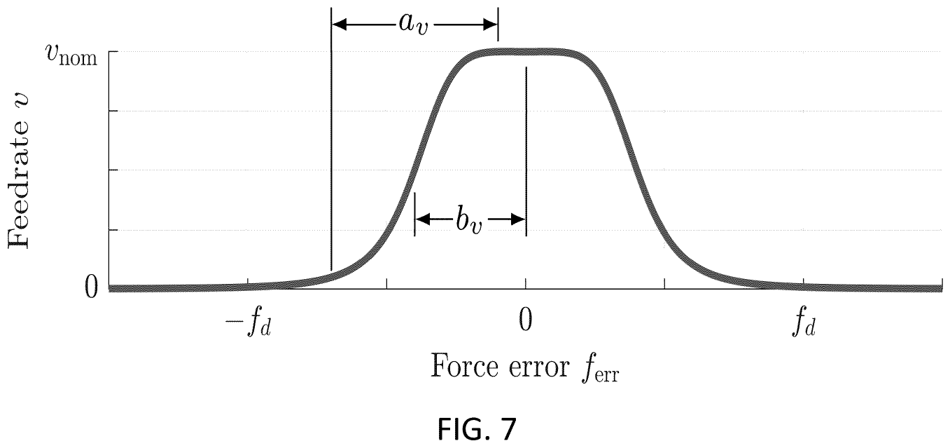

For this embodiment, the feedrate modulation curve shown in FIG. 7 to implement the desired logic. Mathematically, this curve is described by the equation

$$υ = \frac{{υ}_{n o m}}{1 + {\vert \frac{{f}_{err}}{{b}_{υ}} \vert}^{1 / {a}_{ν}}} \qquad ( 4 B )$$

where vₙₒₘ is the nominal feedrate, and αᵥ and bᵥ control the bell curve shape. The parameter αᵥ controls the steepness of the transition distance, with smaller values giving a steeper transition, and bᵥ is the distance to

$$v = \frac{1}{2} {v}_{n o m} ,$$

controlling the width of the bell curve.

The above modifications to the present invention that adjust the spring constant and the feedrate modulation enable the present invention to perform robotic deburring with greater contact stability, while simultaneously being more effective at removing peripheral imperfections such as large burrs, scallops, or index tabs.

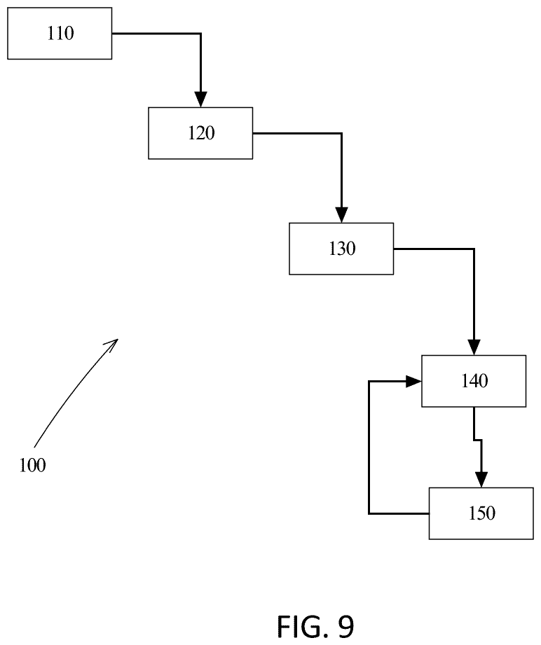

Referring to FIG. 9, a flowchart detailing the steps in a method according to one aspect of the present invention is illustrated. As can be seen, the method 100 begins at step 110, that of obtaining an image of the workpiece to be machined. This step may be accomplished by imaging a planar view of the workpiece using a laser scanner, a computer vision subsystem, an x-ray based subsystem, an acoustic based imaging subsystem or any similar imaging subsystem. Once the workpiece has been imaged, an initial path around the contour of the workpiece is determined (step 120). This step can be accomplished using known tools and methods including well-known CAD/CAM software packages. After the initial path has been determined, then the tool (attached to the industrial robot/manipulator that will control the positioning and motion of the tool) begins to traverse the contour of the workpiece by following the initial path (step 130). While the tool is traversing the contour, a force sensor continuously takes force readings indicative of the force applied by the tool on the surface of the workpiece and these force readings are sent to a data processing subsystem (step 140). Based on the force readings, the path followed by the tool is adjusted so that a predetermined force reading is maintained (step 150). Step 140 and step 150 are repeated and looped until the contour of the workpiece has been machined.

As refinements to the general method, the speed of the tool may be constant or it may be modulated based on the change in position, the force readings, or any other relevant sensed parameters. Similarly, the followed path (i.e., the path followed by the tool around the contour of the workpiece) may be adjusted based on the wear rate/estimated wear of the tool.

As noted above, for a better understanding of the present invention, the following references may be consulted. Each of these references is hereby incorporated in their entirety by reference.
[1] K. M. Murphy, R. J. Norcross, and F. M. Proctor, “CAD directed robotic deburring,” Proc. Second Int. Symp. Robot. Manuf. Res. Educ.Appl. Albuquerque, NM, 1988.
[2] N. Asakawa, K. Toda, and Y. Takeuchi, “Automation of chamfering by an industrial robot; for the case of hole on free-curved surface,” Robot. Comput. Integr. Manuf., vol. 18, no. 5-6, pp. 379-385, 2002.
[3] M. Jinno, M. Uenohara, J. Oaki, and K. Tatsuno, “Teaching-less robot system for finishing workpieces of various shapes using force control and computer vision,” IEEE Int. Conf. Intell. Robot. Syst., vol. 1, pp. 573-578, 1999. vol. 35, pp. 143-151, 2012.
[4] K. Schützer, E. Abele, and S. Güth, “Simulation-based deburring tool and process development,” CIRP Ann.—Manuf. Technol., vol. 64, no. 1, pp. 357-360, 2015.
[5] S. Lloyd, R. A. Irani, M. Ahmadi, Improved accuracy and contact stability in robotic contouring with simultaneous registration and machining, IEEE Trans. Control Syst. Technol. (2024) http://dx.doi.org/10.1109/TCST.2023.3348749.
[6] Roth, G., & Levine, M. D. (1993). Extracting geometric primitives. CVGIP: image understanding, 58(1), 1-22.
[7] Kaiser, A., Ybanez Zepeda, J. A., & Boubekeur, T. (2019 February). A survey of simple geometric primitives detection methods for captured 3D data. In Computer Graphics Forum (Vol. 38, No. 1, pp. 167-196).

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above, all of which are intended to fall within the scope of the invention as defined in the claims that follow.

We claim:

1. A system for automatedly accomplishing machining tasks on a workpiece, the system comprising:
a data processing subsystem for controlling an industrial robot coupled to a machining tool, said data processing subsystem being for controlling said machining tool to follow a contour of said workpiece;
an imaging subsystem for imaging said workpiece, an image of said workpiece being used by said data processing subsystem to determine an initial path for said machining tool to follow around said contour;
a force sensor coupled to a machining tool, said force sensor providing a force reading to said data processing subsystem, said force reading being an amount of force sensed by said force sensor;
wherein
said data processing subsystem adjusts a path for said machining tool based on said force reading;
said machining tool machines said workpiece as said machine tool follows said contour.

2. The system according to claim 1, wherein said machine tool deburrs said contour of said workpiece as said machine tool follows said contour.

3. The system according to claim 1, wherein said imaging subsystem comprises at least one of: a laser scanner, one or more cameras, an x-ray based imaging device, or an acoustic based imaging device.

4. The system according to claim 1, wherein said data processing subsystem adjusts a speed at which said machining tool follows said contour.

5. The system according to claim 4, wherein said data processing subsystem modulates said speed when said force reading is outside a predetermined force range.

6. The system according to claim 1, wherein said data processing subsystem adjusts a speed at which said machining tool follows said perimeter contour based on differences between said path for said machining tool and said initial path.

7. The system according to claim 1, wherein said data processing subsystem adjusts a virtual stiffness parameter based on differences between said path for said machining tool and said initial path.

8. The system according to claim 1, wherein said data processing subsystem applies a velocity correction factor to thereby control a rate at which said path is adjusted.

9. The system according to claim 1, wherein said data processing subsystem adjusts said path based on a rate at which said machining tool wears.

10. A method for machining a workpiece using an industrial robot, the method comprising:
a) obtaining an image of said workpiece;
b) determining an initial path along a contour of said workpiece, said initial path being based on an estimated location of a surface of said contour of said workpiece, wherein a followed path initially conforms to said initial path, said followed path being a path to be followed by said robot with a machine tool along a contour of said workpiece to thereby machine said workpiece;
c) receiving a force reading from a force sensor coupled to said machine tool, said force reading being an indication of a force exerted by said machine tool on said workpiece as said machine tool follows said surface of said contour of said workpiece;
d) adjusting said followed path for said machine tool based on said force reading;
e) repeating steps c) and d) as said machine tool traverses said contour.

11. The method according to claim 10, further comprising adjusting a speed at which said machine tool follows said followed path.

12. The method according to claim 10, wherein step d) is executed to maintain said force reading to be within a predetermined force range.

13. The method according to claim 10, wherein said machine tool traverses said contour at a constant speed.

14. The method according to claim 11, wherein said speed is modulated when said force reading is outside a predetermined force range.

15. The method according to claim 10, wherein said force is modeled as a spring and a spring constant is adjusted based on a difference between said initial path and said followed path such that when said difference is within a predetermined range, said followed path is less likely to deviate from said initial path.

16. The method according to claim 10, further comprising adjusting a virtual stiffness parameter based on differences between said followed path and said initial path.

17. The method according to claim 10, wherein said image is obtained using any one of: a laser scanner, one or more cameras, an x-ray based imaging device, or an acoustic based imaging device.

18. The method according to claim 10, wherein a contour of said workpiece is deburred as said machine tool traverses said contour of said workpiece.

19. The method according to claim 10, further comprising adjusting a speed at which said machine tool follows said followed path based on differences between said followed path and said initial path.

20. The method according to claim 10, further comprising applying a velocity correction factor to thereby control a rate at which said followed path is adjusted.

21. The method according to claim 10, further comprising adjusting said followed path based on a rate at which said machining tool wears.
